(19) United States
(12) Patent Application Publication
(10) Pub. No.: US 2018/0319225 A1
(43) Pub. Date: Nov. 8, 2018

(54) SYSTEM, METHOD, AND APPARATUS FOR TIRE PRESSURE MANAGEMENT

(71) Applicant: Travis Joe Short, Creal Springs, IL (US)

(72) Inventor: Travis Joe Short, Creal Springs, IL (US)

(21) Appl. No.: 15/910,695

(22) Filed: Mar. 2, 2018

Related U.S. Application Data
(60) Provisional application No. 62/501,220, filed on May 4, 2017.

(51) Int. Cl. B60C 23/00

(52) U.S. Cl. CPC B60C 23/003

(57) ABSTRACT

A system, method and apparatus for the management of tire pressure within a wheel assembly of a motor vehicle. The apparatus includes a cylindrical housing carrying the components for coaxial rotation with an axel of the motor vehicle carrying the wheel assembly. The apparatus is configured to vent an over pressure condition to atmosphere and to deliver a pressurized air source to the tire in the event of an under pressure condition. A system includes an apparatus for each wheel assembly of the motor vehicle.

### CROSS-REFERENCE TO RELATED APPLICATION

This application claims the benefit of priority of U.S. provisional application No. 62/501,220, filed May 4, 2017, the contents of which are herein incorporated by reference.

### BACKGROUND OF THE INVENTION

The present invention relates to tire pressure management systems. Proper air pressure management in motor vehicle tires is an essential element for tire performance and mileage. Improper air pressure, particularly under inflation of a motor vehicle tire can lead to premature wear and potential disintegration of the tire.

Fluctuations in the air pressure of vehicle tires used in auto racing is especially critical due to the high performance demands on the tire. Conventional tire pressure management devices in the art rely on the release of air when the air pressure within the tire becomes too great, usually after the tire has reached its operating temperature. However, these devices do not provide for the inflation of the tire when pressure is below specified tolerances.

As can be seen, there is a need for an apparatus and method for tire pressure management that provides for both the inflation of an underinflated tire as well as the release of air in an over pressure condition to improve the performance, safety and longevity of the tires.

### SUMMARY OF THE INVENTION

In one aspect of the present invention a tire pressure management apparatus is disclosed. The tire pressure management apparatus includes a cylindrical housing configured to be received for coaxial rotation with an axle of a motor vehicle. A pressure monitoring line is configured for fluid communication between an interior cavity of a wheel assembly carried by the axle and a pressure sensor carried within the cylindrical housing. A pressure regulation line is configured for fluid communication between the interior cavity of the wheel assembly, a bleed valve, and a source of pressurized air carried within the cylindrical housing. The bleed valve is configured to vent an over pressure condition within the interior cavity to atmosphere upon detection of the over pressure condition by the pressure sensor. The pressurized air source is configured to be delivered to the interior cavity of the wheel assembly in an under pressure condition detected by the pressure sensor.

In some embodiments, the source of pressurized air is a pneumatic pump. The pneumatic pump may be an electric pump. One or more batteries may be carried within the cylindrical housing to selectively power the pneumatic pump. An electrical connector may be configured for connection to an external power source to charge the one or more batteries.

In other embodiments, a microprocessor is operative to receive a pressure signal from the pressure sensor and to control the bleed valve and pneumatic pump responsive to the pressure signal. A display may be operatively connected to the microprocessor and includes one or more controls for adjusting a pressure set point for the tire pressure management system.

Other aspects of the invention, include a method of managing tire pressure in a motor vehicle tire. The method includes installing a tire pressure management apparatus for coaxial rotation with an axle of the motor vehicle. The tire pressure management apparatus includes a cylindrical housing, a pressure sensor, a bleed valve, and a source of pressurized air carried within the cylindrical housing. The bleed valve is configured to vent an over pressure condition within an interior cavity of the wheel assembly to atmosphere upon detection of the over pressure condition by the pressure sensor. The pressurized air source is configured to be delivered to the interior cavity of the wheel assembly in an under pressure condition detected by the pressure sensor. A pressure monitoring line is installed in fluid communication between the interior cavity of the wheel assembly the pressure sensor. A pressure regulation line is also installed in fluid communication between the interior cavity of the wheel assembly, the bleed valve, and the source of pressurized air. The pressure within the interior cavity of the wheel assembly is monitored for a desired tire pressure.

Upon detecting an over pressure condition within the wheel assembly, the bleed valve is operated to vent the over pressure condition to atmosphere. Once the desired tire pressure is obtained, the bleed valve is operated to stop venting. When an under pressure condition is detected within the wheel assembly; the source of pressurized air is operated to deliver air to the wheel assembly via the pressure regulation line. When the desired tire pressure is obtained the source of pressurized air when is stopped. In some practices of the method, a microprocessor is provided to control operation of the bleed valve and the source of pressurized air. The microprocessor may be programmed to set the desired tire pressure.

These and other features, aspects and advantages of the present invention will become better understood with reference to the following drawings, description and claims.

### BRIEF DESCRIPTION OF THE DRAWINGS

FIG. 1 is a perspective view of a tire pressure management apparatus.

FIG. 2 is a front elevation view of the tire pressure management apparatus.

FIG. 3 is a schematic view of a tire pressure management apparatus.

FIG. 4 is a schematic view of an exemplary tire pressure management apparatus installation.

FIG. 5 is a flowchart showing a method of tire pressure management according to aspects of the invention.

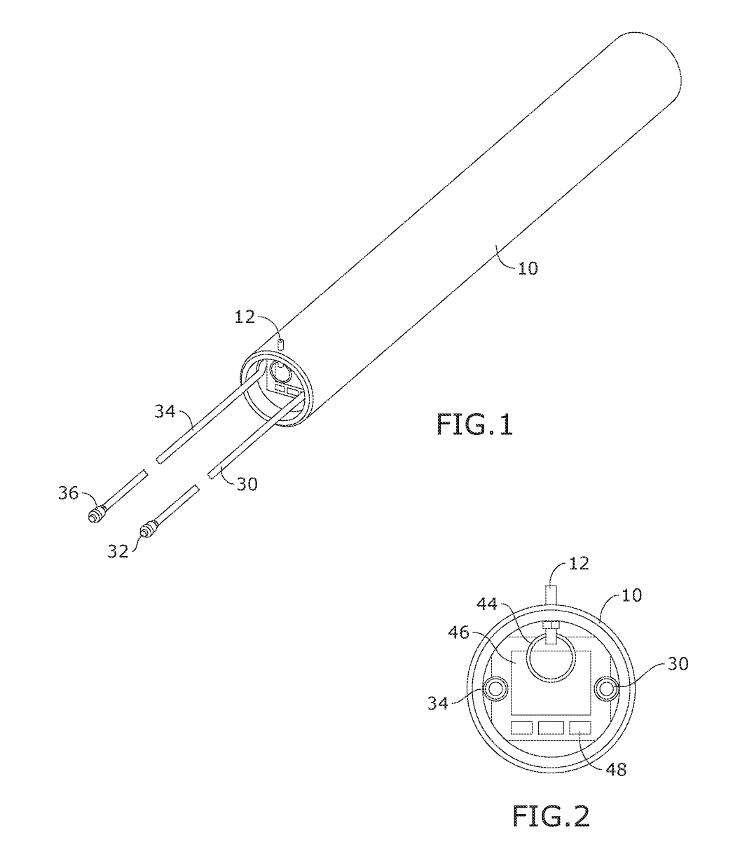

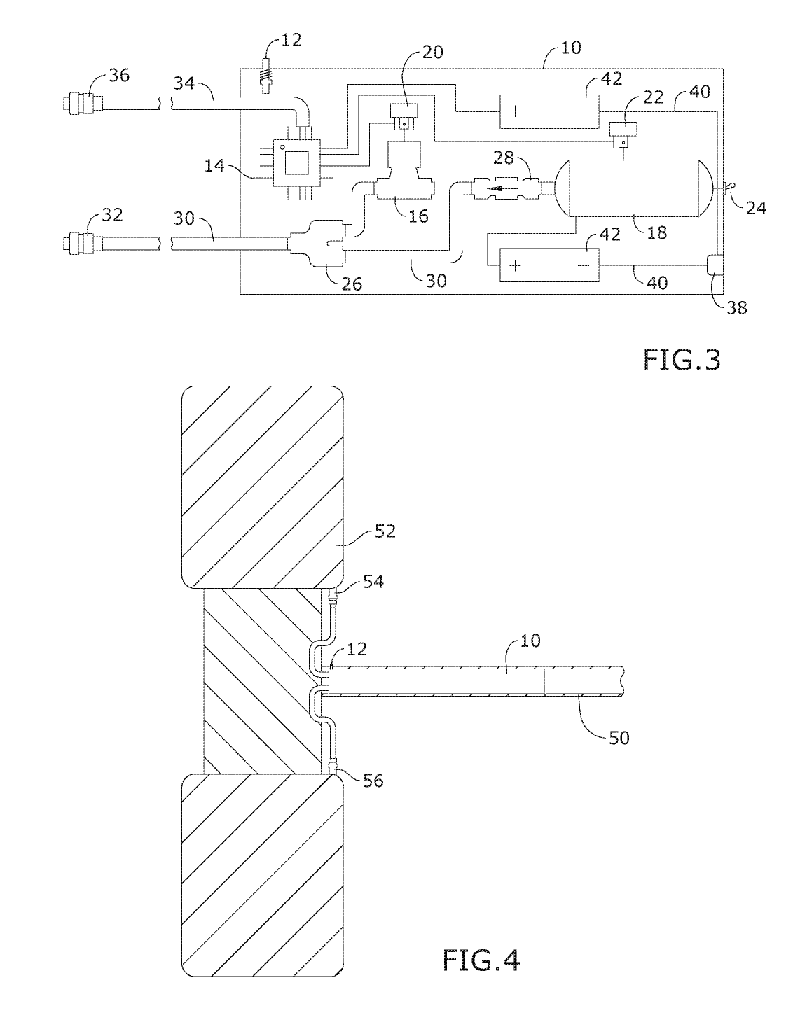

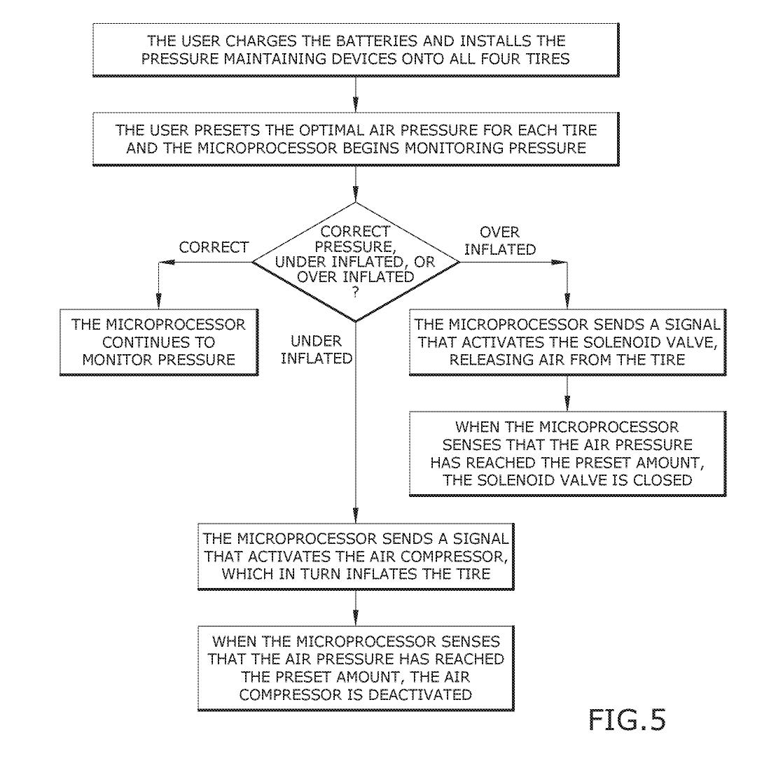

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides an system, apparatus, and method for tire pressure management for motor vehicle tires. The present invention provides for the release of excess pressure in a tire in an over pressure condition and the inflation of the tire in an under pressure condition.

As seen in reference to the drawings, a tire pressure management system according to aspects of the invention includes a cylindrical housing 10 configured to carry components of the tire pressure management apparatus. The cylindrical housing 10 is dimensioned to be rotationally carried with an axel 50 of a motor vehicle carrying a wheel assembly 52. Preferably, the cylindrical housing 10 is carried within the axel 50. For motor sports applications, a quick release pin 12 may be provided for releasable retention of the housing 10 within the axel assembly 50.

An air pressure monitoring line 30 interconnects an interior cavity of the wheel assembly 52 via a pressure sensor 14 carried in the cylindrical housing 10. A coupling 32 connects with a pressure monitoring orifice 54 in fluid communication with the interior cavity of the wheel assembly 52. The pressure sensor 14 monitors the air pressure within the interior cavity of the wheel assembly 52.

An air pressure regulation line 34 is connected to the wheel assembly 52 via a coupling 36 that is operatively connected to a bleed/inflation orifice in fluid communication with the interior cavity of the wheel assembly 52. The air pressure regulation line 34 may be coupled to a splitter 26 having a plurality of outlets/inlets. A first outlet may be coupled to a bleed valve 16 that is operable to release air pressure from within the wheel assembly 52 upon detection of an over pressure condition by the pressure sensor 14. In certain embodiments, a first relay 20 may be activated so as to operate the bleed valve 16 to vent the excess air pressure to the atmosphere. The bleed valve 16 may include a solenoid that is operable responsive to an electrical signal from the first relay 20.

Preferably, particularly when utilized with a race car, the couplings 32, 36 and their associated orifice 54, 56 are quick disconnect couplings to permit the apparatus to be quickly removed and installed from the motor vehicle.

The air pressure regulation line 34 splitter 26 may also be connected in fluid communication with a check valve 28 that is operatively coupled to an outlet of a pneumatic pump 18 via a pneumatic tube 30. The check valve 28 is operable to permit flow from the pneumatic pump 18 to the pressure regulation line 34 and prevent back flow through the check valve 28. The pneumatic pump, or compressor 18 may also be carried within the cylindrical housing 10 and is configured to provide a pressurized air source for the tire pressure management system. The pneumatic pump 18 may be an electric pump that is operated by an electrical source, such as one or more batteries 42 carried within the housing 10. A charging port 38 may also be provided to connect to an external power source to provide an electrical charge to the batteries 42.

The pneumatic pump 18 is placed into operation when the pressure sensor 14 detects an under pressure condition within the interior cavity of the wheel assembly 52. In certain embodiments, a second relay 22 is may be activated to place the pneumatic pump 18 in an operational condition. The pneumatic pump 18 may be operated until the desired pressure is obtained within the interior cavity of the wheel assembly 52 at which time the pressure sensor 14 senses the desired pressure and deactivates the second relay 22.

As will be appreciated, the pressure sensor 14 may be programmable to allow the user to set a desired tire pressure for the wheel assembly 52 to which the tire pressure management system is coupled. A microprocessor may also be included to control the signals to the electrical components of the system. The microprocessor may also include a display 46 and one or more buttons 48 are provided to permit the operator to set the operational parameters of the system. The display 46 may present the desired set pressure and concurrently, or alternatively present the actual pressure within the wheel assembly 52 to present the user a visual depiction of the system operational parameters. The system may also include a switch 24 to permit the operator to turn the system on and off, to conserve battery power when the system is not needed.

As seen in reference to FIG. 4, a method according to aspects of the invention includes installing a tire pressure management apparatus on each wheel assembly of the motor vehicle. When provided, programming the tire pressure management apparatus to a desired tire pressure. In operation, each tire pressure management apparatus will monitor the tire pressure within the interior cavity of the respective wheel assemblies for the desired pressure. If an over pressure condition is detected, the bleed valve is activated to vent the excess pressure to atmosphere. Upon detection of that the desired pressure has been attained, the bleed valve is closed to prevent further venting. Upon detecting an over pressure condition, the pneumatic pump is activated to deliver pressurized air to the interior cavity of the wheel assembly. When the desired pressure has been attained, the pneumatic pump is deactivated, and the system continues to monitor the pressure within the wheel assembly.

It should be understood, of course, that the foregoing relates to exemplary embodiments of the invention and that modifications may be made without departing from the spirit and scope of the invention as set forth in the following claims.

What is claimed is:

1. A tire pressure management apparatus, comprising:
a cylindrical housing configured to be received for coaxial rotation with an axle of a motor vehicle;
a pressure monitoring line configured for fluid communication between an interior cavity of a wheel assembly carried by the axle and a pressure sensor carried within the cylindrical housing;
a pressure regulation line configured for fluid communication between the interior cavity of the wheel assembly, a bleed valve, and a source of pressurized air carried within the cylindrical housing, wherein the bleed valve is configured to vent an over pressure condition within the interior cavity to atmosphere upon detection of the over pressure condition by the pressure sensor; and the pressurized air source is configured to be delivered to the interior cavity of the wheel assembly in an under pressure condition detected by the pressure sensor.

2. The tire pressure management apparatus of claim 1, wherein the source of pressurized air is a pneumatic pump.

3. The tire pressure management apparatus of claim 2, wherein the pneumatic pump is an electric pump.

4. The tire pressure management apparatus of claim 3, further comprising:
one or more batteries carried within the cylindrical housing to selectively power the pneumatic pump.

5. The tire pressure management apparatus of claim 4; further comprising:
an electrical connector configured for connection to an external power source to charge the one or more batteries.

6. The tire pressure management apparatus of claim 3, further comprising:
a micro processor operative to receive a pressure signal from the pressure sensor and to control the bleed valve and pneumatic pump responsive to the pressure signal.

7. The tire pressure management apparatus of claim 6, further comprising:
a display operatively connected to the micro processor; and
one or more controls for adjusting a pressure set point for the tire pressure management system.

8. A method of managing tire pressure in a motor vehicle tire, comprising:
installing a tire pressure management apparatus for coaxial rotation with an axle of the motor vehicle, the tire pressure management apparatus including a cylindrical housing, a pressure sensor, a bleed valve, and a source of pressurized air carried within the cylindrical housing, wherein the bleed valve is configured to vent an over pressure condition within an interior cavity of a wheel assembly to atmosphere upon detection of the over pressure condition by the pressure sensor; and the pressurized air source is configured to be delivered to the interior cavity of the wheel assembly in an under pressure condition detected by the pressure sensor;
installing a pressure monitoring line in fluid communication between the interior cavity of the wheel assembly the pressure sensor;
installing a pressure regulation line in fluid communication between the interior cavity of the wheel assembly, the bleed valve, and the source of pressurized air; and
monitoring the pressure within the interior cavity of the wheel assembly for a desired tire pressure.

9. The method of claim 8, further comprising:
detecting an over pressure condition within the wheel assembly; and
operating the bleed valve to vent the over pressure condition to atmosphere.

10. The method of claim 9, further comprising:
operating the bleed valve to stop venting when the desired tire pressure is obtained.

11. The method of claim 8, further comprising:
detecting an under pressure condition within the wheel assembly; and
operating the source of pressurized air to deliver air to the wheel assembly via the pressure regulation line.

12. The method of claim 11, further comprising:
stopping operation of the source of pressurized air when the desired tire pressure is obtained.

13. The method of claim 8, further comprising:
providing a microprocessor to control operation of the bleed valve and the source of pressurized air; and
programming the microprocessor to set the desired tire pressure.
